(19) United States
(12) Patent Application Publication
(10) Pub. No.: US 2025/0292424 A1
(43) Pub. Date: Sep. 18, 2025

(54) IMAGE PROCESSING METHOD, ELECTRONIC DEVICE, AND STORAGE MEDIUM

(71) Applicant: Lenovo (Beijing) Limited, Beijing (CN)

(72) Inventors: Kaiyue CHEN, Beijing (CN); Wanjun LV, Beijing (CN); Xianchen LIANG, Beijing (CN)

(21) Appl. No.: 19/068,440

(22) Filed: Mar. 3, 2025

(30) Foreign Application Priority Data
Mar. 15, 2024 (CN) 202410302278.8

(51) Int. Cl. G06T 7/579; G06T 5/50; G06T 7/246

(52) U.S. Cl. CPC G06T 7/579; G06T 5/50; G06T 7/248; G06T 2207/30241

(57) ABSTRACT

An image processing method, an electronic device, and a storage medium are provided in the present disclosure. The method includes obtaining a plurality of frames of first images; predicting depth information of the moving object to obtain first depth prediction information of the moving object in the plurality of frames of first images; obtaining moving trajectory information of the moving object in the plurality of frames of first images; according to the moving trajectory information of the moving object in the plurality of frames of first images, performing a correction processing on the first depth prediction information of the moving object in the plurality of frames of first images to obtain second depth prediction information of the moving object in the plurality of frames of first images; and converting the plurality of frames of first images into a plurality of frames of second images for three-dimensional effect output.

### CROSS-REFERENCE TO RELATED APPLICATION

This application claims the priority of Chinese Patent Application No. 202410302278.8, filed on Mar. 15, 2024, the content of which is incorporated herein by reference in its entirety.

### TECHNICAL FIELD

The present disclosure generally relates to the field of image processing and three-dimensional display technology, and, more particularly, relates to, an image processing method, an electronic device, and a storage medium.

### BACKGROUND

The biggest difference between 3D (two-dimensional) stereoscopic image display and 2D (three-dimensional) planar image display is the sense of depth in the visuals; that is, the depth effect of the picture depth visually reflected. The depth effect is divided into the out-of-screen effect and the into-screen effect. The out-of-screen effect makes an object in the image look like protruding from the display screen (e.g., a soccer ball flying out of the screen), while the into-screen effect is the opposite, which makes the object in the image look like extending inword into the screen (e.g., a soccer ball flying into the screen). The designs of the out-of-screen and into-screen effects are to show three-dimensional feel of the pictures, providing the viewers with a 3D experience.

2D-3D conversion technology is a technology configured to produce three-dimensional images based on two-dimensional images, which may require depth prediction of pixels in two-dimensional images to achieve the conversion of two-dimensional images to three-dimensional images. Since the monocular absolute depth prediction is not accurate enough, when pursuing the into-screen/out-of-screen effect to obtain the sense of depth of the pictures, the existing 2D-3D conversion algorithms may use normalized relative depth prediction results to generate images for 3D effect presentation. However, such processing manner may make the into-screen/out-of-screen effect in 3D display less realistic, which may affect the user's experience of 3D into-screen/out-of-screen effect.

### SUMMARY

One aspect of the present disclosure provides an image processing method. The method includes obtaining a plurality of frames of first images, where the plurality of frames of first images includes imaging information of a moving object; predicting depth information of the moving object in the plurality of frames of first images to obtain first depth prediction information of the moving object in the plurality of frames of first images; obtaining moving trajectory information of the moving object in the plurality of frames of first images; according to the moving trajectory information of the moving object in the plurality of frames of first images, performing a correction processing on the first depth prediction information of the moving object in the plurality of frames of first images to obtain second depth prediction information of the moving object in the plurality of frames of first images; and according to the second depth prediction information of the moving object in the plurality of frames of first images, converting the plurality of frames of first images into a plurality of frames of second images for three-dimensional effect output.

Another aspect of the present disclosure provides an electronic device. The electronic device includes a memory, configured to store a computer program; and one or more processors, configured to, when the computer program is executed, perform an image processing method. The method includes obtaining a plurality of frames of first images, where the plurality of frames of first images includes imaging information of a moving object; predicting depth information of the moving object in the plurality of frames of first images to obtain first depth prediction information of the moving object in the plurality of frames of first images; obtaining moving trajectory information of the moving object in the plurality of frames of first images; according to the moving trajectory information of the moving object in the plurality of frames of first images, performing a correction processing on the first depth prediction information of the moving object in the plurality of frames of first images to obtain second depth prediction information of the moving object in the plurality of frames of first images; and according to the second depth prediction information of the moving object in the plurality of frames of first images, converting the plurality of frames of first images into a plurality of frames of second images for three-dimensional effect output.

Another aspect of the present disclosure provides a non-transitory computer-readable storage medium, containing a computer program for when executed by one or more processors, performing an image processing method. The method includes obtaining a plurality of frames of first images, where the plurality of frames of first images includes imaging information of a moving object; predicting depth information of the moving object in the plurality of frames of first images to obtain first depth prediction information of the moving object in the plurality of frames of first images; obtaining moving trajectory information of the moving object in the plurality of frames of first images; according to the moving trajectory information of the moving object in the plurality of frames of first images, performing a correction processing on the first depth prediction information of the moving object in the plurality of frames of first images to obtain second depth prediction information of the moving object in the plurality of frames of first images; and according to the second depth prediction information of the moving object in the plurality of frames of first images, converting the plurality of frames of first images into a plurality of frames of second images for three-dimensional effect output.

Other aspects of the present disclosure may be understood by those skilled in the art in light of the description, the claims, and the drawings of the present disclosure.

### BRIEF DESCRIPTION OF THE DRAWINGS

To clearly describe the technical solutions of various embodiments of the present disclosure, the drawings need to be used for describing various embodiments are described below. Obviously, the drawings in following description are merely some embodiments of the present disclosure. For those skilled in the art, other drawings may be obtained in accordance with these drawings without creative efforts.

FIG. 1 illustrates a flowchart of an image processing method according to various embodiments of the present disclosure.

FIG. 2 illustrates an exemplary scene where a soccer ball flies toward a wall and bounces back according to various embodiments of the present disclosure.

FIG. 3 illustrates another flowchart of an image processing method according to various embodiments of the present disclosure.

FIG. 4 illustrates another flowchart of an image processing method according to various embodiments of the present disclosure.

FIG. 5 illustrates a compositional structural schematic of an image processing apparatus according to various embodiments of the present disclosure.

### DETAILED DESCRIPTION

The technical solutions in embodiments of the present disclosure are clearly and completely described below with reference to the accompanying drawings in embodiments of the present disclosure. Obviously, described embodiments are only a part of embodiments of the present disclosure, but not all embodiments. Based on embodiments in the present disclosure, all other embodiments obtained by those skilled in the art without creative efforts shall fall within the protection scope of the present disclosure.

Various embodiments of the present disclosure provide an image processing method and an electronic device. The image processing method and the electronic device may be applied to, but may be not limited to, the conversion scene of two-dimensional images to three-dimensional images and may be configured to enhance the 3D into-screen/out-of-screen effect of converted three-dimensional images, such that the into-screen/out-of-screen effect in 3D display may be more realistic and natural. The image processing method provided by embodiments of the present disclosure may be used in various general or special computing device environments or electronic devices under configuration, including personal computers, handheld devices or portable devices, tablet devices, multi-processor devices, and the like.

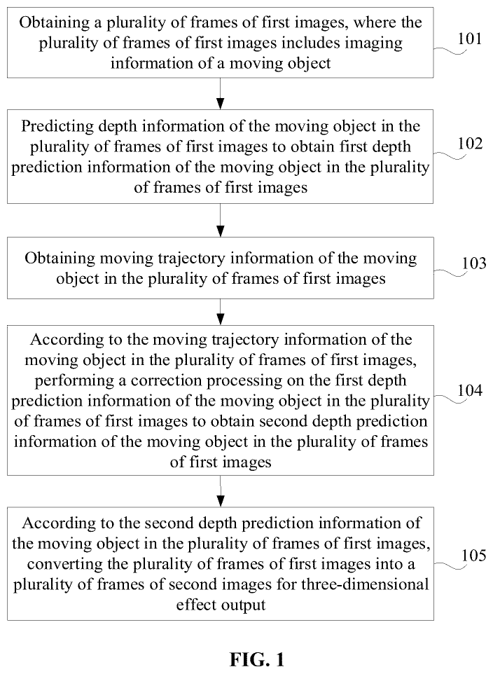

Referring to the flowchart of the image processing method shown in FIG. 1, the image processing method provided in embodiments of the present disclosure may at least include following exemplary processing steps.

At 101, a plurality of frames of first images may be obtained, where the plurality of frames of first images may include imaging information of a moving object.

The plurality of frames of first images may be the plurality of two-dimensional images to be converted into three-dimensional images, which may be, but may be not limited to, the plurality of frames of images in a 2D video or a moving picture.

The plurality of frames of first images may be the plurality of continuous image frames in a 2D video or a moving picture. Or the plurality of frames of first images may be non-continuous image frames in a 2D video or a moving picture. In such case, the plurality of frames of first images may satisfy continuity condition to ensure continuity between the image contents of the plurality of frames of first images, thereby ensuring continuity of visual effects presented by the plurality of frames of first images when the plurality of frames of first images is displayed.

In embodiments of the present disclosure, the continuity condition herein is referred to as the first continuity condition. The first continuity condition may be a condition in terms of time or frame number. Optionally, the first continuity condition may be, for example, set to that the time interval between each two adjacent frames of first images does not exceed a predetermined time length, or the frame number difference between each two adjacent frames of first images does not exceed a predetermined value.

The time corresponding to the first image may refer to the acquisition time or the playback progress time of first images (i.e., the time/moment corresponding to the playback progress).

In an implementation, optionally, when the plurality of frames of images in a 2D video or a moving picture needs to be converted into three-dimensional images, the 2D video or moving picture may be decomposed into image frames, and all decomposed image frames may be directly read to obtain the plurality of frames of first images, such that subsequent conversion processing from two-dimensional images to three-dimensional images may be performed on the plurality of frames of first images; or based on actual requirements of resource occupancy or processing complexity, combined with above-mentioned first continuity condition, frames may be selected from all decomposed image frames; that is, a portion of the image frames may be selectively read as the plurality of frames of first images. It should be noted that in such implementation, each selectively read frame may meet above-mentioned first continuity condition.

The plurality of frames of first images may include imaging information of moving objects, for example, imaging information of entire movement process of a soccer ball from flying to a wall and bouncing back from the wall. The number of moving objects included therein may be not limited, and may be one or more, which may be selected according to actual situation.

At 102, the depth information of the moving object in the plurality of frames of first images may be predicted to obtain the first depth prediction information of the moving object in the plurality of frames of first images.

Optionally, for example, the absolute depth of the moving object in the first image of the plurality of frames may be obtained by monocular absolute depth prediction; and predicted absolute depth may be configured as the first depth prediction information of the moving object in the plurality of frames of first images.

Monocular absolute depth prediction refers to absolute depth prediction of a monocular image. The monocular image may be a two-dimensional projection of a visual cone in a three-dimensional world, and the depth information may be lost. The absolute depth of the imaging object (such as a moving object or a non-moving object) may reflect real distance between the imaging object and an image acquisition apparatus. The absolute depth of the imaging object may exemplarily include the absolute depth of each pixel on the imaging object, that is, include the distance between each pixel on the imaging object and the image acquisition apparatus.

It should be understood that the image acquisition apparatus herein may be an image acquisition apparatus that performs image acquisition on the imaging object to achieve imaging, such as an RGB (red-green-blue) camera that performs image acquisition on the imaging object and the like.

In an optional implementation manner, 102 (exemplary step) may be implemented as follows: predicting the depth information of each pixel in the plurality of frames of first images to obtain pixel depth prediction information; obtaining a moving object identification result obtained by identifying the moving object in the plurality of frames of first images; and on such basis, determining the depth information of the moving object in the plurality of frames of first images according to the pixel depth prediction information and the moving object identification result.

For example, the moving object in the first image may be identified by semantically segmenting the first image; and by mapping the pixel depth prediction information of each pixel in the first image to the moving object characterized by the semantic segmentation result of the first image according to the pixel position, the first depth prediction information of the moving object in the first image may be obtained. The first depth prediction information of the moving object in the first image may exemplarily include the pixel depth prediction information of each pixel on the moving object in the first image, such as absolute depth prediction value of each pixel.

Semantic segmentation of the image may be to understand the image at the pixel level, and the goal may be to accurately understand the scene and content of the image. Semantic segmentation may be, for example, classification at the pixel level. Pixels belonging to same category may be identified and classified into one category, such that, pixel classification may be configured to identity various elements with complete semantics in the image, such as various foreground objects such as people, animals, soccer balls and the like, and various background objects such as green space, sky, trees and the like.

In practical applications, the depth information of the moving object may be not limited to above-mentioned implementation manners. In other implementation manners, the moving object identification result obtained by identifying the moving object in the plurality of frames of first images may be first acquired, and the depth information of each pixel on the moving object characterized by the identification result may be only predicted in a targeted manner to obtain the first depth prediction information of the moving object in the first image. For example, the semantic segmentation result obtained by semantically segmenting the first image may be first acquired, and on such basis, the absolute depth of each pixel on the moving object characterized by the semantic segmentation result may be predicted in a targeted manner.

Predicting the depth information of the moving object in the plurality of fames of first images may exemplarily refer to performing the prediction processing of the depth information of the moving object on each first image in the plurality of fames of first images. However, predicting the depth information may be not limited herein, and may also refer to performing the prediction processing of the depth information of the moving object on a part of first images in the plurality of fames of first images. For example, when performing depth prediction of the moving object on the plurality of fames of first images, there may have frame omission scenario, or only a part of the frames may be selectively extracted from the plurality of fames of first images for depth prediction of the moving object. It should be noted that in such implementation manner, optionally, such part of first images may satisfy the continuity condition (the continuity condition herein is referred to as the second continuity condition in embodiments of the present disclosure), which may ensure that continuity may be between the image contents of first images of all frames used in the depth prediction, thereby ensuring that visual effects presented by the first images of all frames used in the depth prediction may be continuous when the first images are displayed.

The second continuity condition may be similar to the first continuity condition and may also be a condition in terms of time or frame number. That is, by constraining the time interval (acquisition time, playback progress time or the like) or frame number difference between each two adjacent frames of first images used in depth prediction, the continuity between all frames of first images used in depth prediction may be ensured.

At 103, the moving trajectory information of the moving object in the plurality of frames of first images may be obtained.

Optionally, in an implementation, the moving trajectory information of the moving object in the plurality of fames of first images may be obtained by semantically segmenting the plurality of fames of first images and tracking the moving objects identified based on the semantic segmentation.

The execution order of 103 and 102 may be not limited in the present disclosure. Any one of two exemplary steps may be executed first, and another one may be executed later, or two exemplary steps may be executed in parallel. In practical applications, exemplary step executed later may reuse the semantic segmentation result of exemplary step executed earlier.

The moving trajectory information of the moving object in the plurality of fames of first images may include a position information sequence of the moving object in each first image, which may be, but may be not limited to, a series of time points (acquisition time points or playback progress time points) or corresponding relationship between frame numbers and the positions of the moving object in the first image, for example: time point 1/frame number 1−moving object position 1; time point 2/frame number 2−moving object position 2; . . . time point n/frame number n−moving object position n, where n may be an integer greater than 1.

In practical applications, the moving trajectory information (the position information sequence) of the moving object may include the position information of the moving object in each frame of first images included in the plurality of frames of first images; that is, each frame of first images may be used in semantic segmentation and target tracking of the moving object based on semantic segmentation. Or the moving trajectory information of the moving object may also only include the position information of the moving object in a part of first images; that is, only the part of first images may be used in semantic segmentation and target tracking of the moving object based on semantic segmentation. In such implementation manner, the part of first images used in semantic segmentation and target tracking of the moving object based on semantic segmentation should satisfy the third continuity condition, which may ensure that obtained moving trajectory information may effectively characterize the moving trajectory of the moving object.

The third continuity condition may also be a condition in terms of time or frame number and similar to the first continuity condition and the second continuity condition mentioned above, which may refer to the description of the first continuity condition and the second continuity condition mentioned above and may not be described in detail herein.

At 104, according to the moving trajectory information, the first depth prediction information of the moving object in the plurality of frames of first images may be corrected to obtain the second depth prediction information of the moving object in the plurality of frames of first images.

In embodiments of the present disclosure, after obtaining the moving trajectory information of the moving object, the first depth prediction information of the moving object in the plurality of frames of first images of the image may be further corrected according to the moving trajectory information of the moving object. Optionally, for example, the change feature of the moving trajectory of the moving object may be determined according to the moving trajectory information of the moving object, and the first depth prediction information of the moving object in the plurality of frames of first images of the image may be corrected according to the change feature of the moving trajectory of the moving object.

The change feature of the moving trajectory of the moving object may include, but may be not limited to, the turning point of the trajectory on the moving trajectory of the moving object, and the depth change trend of the moving object before and after the turning point of the trajectory, such as monotonically increasing or decreasing depth. The turning point of the trajectory may be a point on the moving trajectory configured to characterize the change in the moving direction of the moving object.

The turning point information of the trajectory turning point may include, but may be not limited to, the time point (the acquisition time point or playback progress time point) or frame number corresponding to the first image to which the trajectory turning point belongs, and the position information corresponding to the first image to which the trajectory turning point belongs.

When the first depth prediction information of the moving object in the first images of the plurality of frames is corrected according to the change feature of the moving trajectory of the moving object, it may determine whether the first depth prediction information of the moving object in each frame of first images is consistent with corresponding change trend according to the turning point information of the trajectory on the moving trajectory and the depth change trend of the moving object before and after the turning point of the trajectory; and the first depth prediction information that is not consistent with corresponding change trend may be corrected to the information consistent with corresponding depth change trend.

Optionally, for example, the correction result of the first depth prediction information that is not consistent with corresponding change trend may be fitted according to previous first depth prediction information that is not consistent with the change trend and/or later first depth prediction information that is consistent with corresponding change trend. The correction result may be the second depth prediction information corresponding to the first depth prediction information that is not consistent with corresponding change trend.

An exemplary correction processing is described in detail hereinafter. Monocular absolute depth prediction is not accurate enough, and there may always be depth prediction errors in a single moving direction. In the application scenario of 2D to 3D conversion, depth prediction errors may result in jitter and instability during the moving process of the moving object in the 3D video. Exemplarily, for the example of “the soccer ball flies toward the wall and bounces back”, the depth of the wall is assumed to be 1, and actual depth change of the soccer ball in the process of flying toward the wall is assumed to be a monotonically increasing from 0.5 to 1. However, in the monocular absolute depth prediction, the prediction result of the depth information of the soccer ball may be not accurate enough. For example, the first depth prediction information of the soccer ball obtained by monocular absolute depth prediction may include 0.5->0.52->0.51->0.54-> . . . >1. When 2D to 3D conversion is performed, such prediction result may result in jitter and instability during the moving process of the soccer ball in the 3D video. Main reason is that the depth value of 0.51 in the prediction result may be not consistent with monotonically increasing depth trend of the soccer ball in the process of “the soccer ball flies toward the wall”. Based on embodiments of the present disclosure, the depth prediction value 0.51 may be detected and corrected to a value that is consistent with corresponding depth change trend. For example, 0.51 may be corrected to 0.53 according to 0.52(previously adjacent to 0.51) and 0.54 (next adjacent to 0.51), such that the corrected depth value may be consistent with corresponding depth change trend, jitter and instability during the moving process of the moving object in converted 3D video may be avoided accordingly.

At 105, the plurality of frames of first images may be converted into the plurality of frames of second images for three-dimensional effect output according to the second depth prediction information.

After the first depth prediction information of the moving object in the plurality of fames of first images is corrected to obtain the second depth prediction information of the moving object in the plurality of fames of first images, the plurality of fames of first images may be further converted into the plurality of fames of second images for three-dimensional effect output according to the second depth prediction information. Optionally, such process may be implemented as follows: obtaining the three-dimensional position information of the moving object in the first images and generating the left disparity images and the right disparity images for three-dimensional effect output corresponding to the first images according to the three-dimensional position information of the moving object in the first images.

The three-dimensional position information of the moving object in the first image may include the planar position corresponding to the moving object in the first image, and the second depth prediction information of the moving object in the first image.

The left disparity images and the right disparity images corresponding to the first images may be configured as the second images corresponding to the first images for outputting three-dimensional effect; that is, the second images corresponding to the first images may include the left disparity images and the right disparity images corresponding to the first images. Subsequently, the left disparity image and the right disparity image corresponding to each frame of the first image may be interlaced, and interlaced result image may be displayed on the glass-free 3D display screen to present 3D visual effects such as into-screen/out-of-screen.

It should be noted that in response to the first depth prediction information of the moving object in the first image being consistent with corresponding depth change trend, the second depth prediction information of the moving object in the first image may still be corresponding first depth prediction information after the correction processing is completed. The goal of depth correction may be to correct the first depth prediction information of the moving object not consistent with corresponding depth change trend to the first depth prediction information consistent with corresponding depth change trend; and for the first depth prediction information that is consistent with corresponding depth change trend, the value of the first depth prediction information may be maintained.

As disclosed above, the image processing method in embodiments of the present disclosure provides the technical solution of performing correction processing on the depth prediction information of the moving object based on the moving trajectory information of the moving object in the conversion from two-dimensional images to three-dimensional images. The moving trajectory information of the moving object may reflect the depth change pattern of the moving object during the moving process. For example, the depth information of the soccer ball may increase monotonically when flying to the wall and may decrease monotonically when bouncing back from the wall. Therefore, the correction processing may be performed on the depth prediction information of the moving object based on the moving trajectory information of the moving object, such that the depth prediction result of the corrected moving object may be closer to real depth of the moving object, and the into-screen/out-of-screen effect in the 3D display may be more realistic and natural, thereby improving 3D into-screen/out-of-screen effect experience of the users.

In an optional embodiment, in response to that the first images used in the depth prediction and depth correction processing only include a part of the first images in the plurality of frames of first images, that is, a certain number of first images are omitted (e.g., unused), for omitted first images, the second depth prediction information of each first image used in the depth prediction and correction processing and corresponding depth change trend may be combined with the positions of the omitted first images in the image sequence formed by the plurality of frames of first images, and the depth values of the moving object in omitted first images may be fitted to complete the depth values of the moving object in the plurality of frames of first images, thereby facilitating subsequent 2D to 3D conversion of the plurality of frames of first images.

For the scenario that only a part of the first images is used in the depth prediction and correction processing, in one embodiment, richer depth information of the moving object during the movement process may be obtained by completing (e.g., adding) the depth values of the moving object in omitted first images, which may be convenient to obtain a more continuous, natural and realistic 3D visual effect of the moving object during the conversion process of the two-dimensional images to the three-dimensional images.

However, in practical applications, the processing manner may be not limited to above implementation. For the omitted frames, the depth information of the moving object may not be completed but may be directly eliminated. That is, the omitted image frames may be not used in the 2D to 3D processing, as long as all frames of the first images that finally are used in the 2D to 3D processing (that is, the conversion processing of exemplary step 105) are guaranteed to have continuity in image contents, and the 3D contents finally converted have visual effect continuity correspondingly.

In an optional embodiment, 103 (exemplary step) of the method provided by the present disclosure, i.e., obtaining the moving trajectory information of the moving object in the plurality of frames of first images, may be further implemented as obtaining the monotonic directional trajectory information of the moving object in the plurality of frames of first images.

The monotonic directional trajectory information may be configured to characterize the monotonic change direction of the depth information monotonic increase or monotonic decrease of the moving object in corresponding time period or frame number range.

Corresponding time periods or frame number ranges may be divided based on the trajectory turning points on the moving trajectory of the moving object.

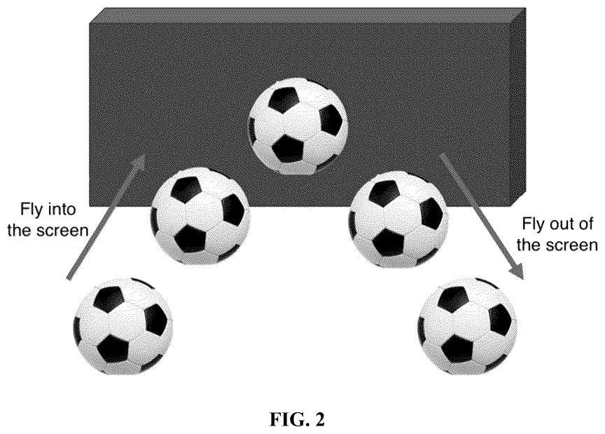

Referring to the exemplary scene of the soccer ball flying toward the wall and bouncing back provided in FIG. 2, in such example, the movement trajectory of the soccer ball may include entire trajectory curve of the soccer ball flying toward the wall and bouncing back from the wall. The turning point of the trajectory may be the contact point between the soccer ball and the wall. Based on the turning point of the trajectory, two time periods/frame number ranges may be divided: the first time period/first frame number range from the soccer ball flying toward the wall to contacting the wall, and the second time period/second frame number range from the contact point with the wall to bouncing back to the wall. The first time period/first frame number range may correspond to the movement trajectory of the soccer ball from the beginning of flying toward the wall to contacting the wall, which may be, in the 3D display, presented as visual effect of the soccer ball flying from outside the screen into the screen (i.e., into-screen); and corresponding trajectory information may be the first monotonic directional trajectory information for characterized the depth change direction as the depth monotonical increase. The second time period/second frame number range may correspond to the movement trajectory of the soccer ball from the contact point with the wall to bouncing back to the wall, which may be, in the 3D display, presented as visual effect of the soccer ball flying out of the screen from the screen (i.e., out-of-screen); and corresponding trajectory information may be the second monotonic directional trajectory information for characterized the depth change direction as the depth monotonical decrease.

In an optional embodiment, exemplarily, the monotonic directional trajectory information of the moving object configured and inputted by the user according to the moving process of the moving object in the plurality of frames of first images may be obtained. For example, the user may input the monotonic directional trajectory information of “the depth of the soccer ball monotonically increases in the 3-5 seconds of the video” according to the moving process of the soccer ball.

In other optional implementations, the monotonic directional trajectory information of the moving object analyzed and determined according to the moving process of the moving object in the plurality of frames of first images may also be obtained. In such implementation, the execution subject (such as a personal computer or a server) may automatically analyze and determine the monotonic directional trajectory information of the moving object by performing feature analysis on the moving trajectory of the moving object, such as analyzing the turning points on the trajectory line and the depth change direction before and after the turning points and the like. Exemplarily, for the example of the soccer ball flying toward the wall and bouncing back, the monotonic directional trajectory information of “the depth of the soccer ball monotonically increases in the 3-5 seconds of the video” and the monotonic directional trajectory information of “the depth of the soccer ball monotonically decreases in the 5-7 seconds of the video” may be determined through automatic analysis.

On the basis of obtaining the monotonic directional trajectory information of the moving object in the plurality of frames of first images, the first depth prediction information of the moving object in the plurality of frames of first images may be further corrected based on the monotonic directional trajectory information of the moving object to obtain the second depth prediction information of the moving object in the plurality of frames of first images.

The process of correcting the first depth prediction information of the moving object in the first images of the plurality of frames based on the monotonic directional trajectory information of the moving object may be further implemented as the following:
(1) the first depth prediction information of the moving object in each frame of first images may be matched with corresponding monotonic directional trajectory information according to corresponding time (acquisition time or playback progress time) or frame number; and
(2) according to the monotonic change direction of the depth information characterized by matched monotonic directional trajectory information, the first depth prediction information of the moving object in each frame of first images may be corrected, such that the second depth prediction information of the moving object in each frame of first images after correction may be consistent with the monotonic change direction of the depth information characterized by matched monotonic directional trajectory information.

Exemplarily, when correcting the first depth prediction information of the moving object in each frame of first images, the first depth prediction information of each first depth prediction information of the moving object on each frame of first images that is not consistent with corresponding monotonic change direction may be corrected to be consistent with corresponding monotonic change direction.

Furthermore, optionally, the correction result (i.e., the second depth prediction information) of the first depth prediction information that is not consistent with corresponding monotonic change direction may be fitted according to previous first depth prediction information that is consistent with corresponding monotonic change direction and/or later first depth prediction information that is not consistent with corresponding monotonic change direction.

Still taking the scene of the soccer ball flying toward the wall and bouncing back as an example, the prediction result “0.5->0.52->0.51->0.54-> . . . >1” may be matched to the first monotonic directional trajectory of the soccer ball from the beginning of flying toward the wall to contacting the wall, and the first depth prediction information 0.51 that is not consistent with the depth monotonic change direction (depth monotonic increase) characterized by the first monotonic directional trajectory may be corrected to corresponding depth value that is consistent with the depth monotonic change direction characterized by the first monotonic directional trajectory, for example, may be corrected to 0.53.

In an implementation, the correction value (i.e., the second depth prediction information) corresponding to the first depth prediction information that is not consistent with corresponding depth change trend/depth monotonous change direction may be fitted by, but may be not limited to, polynomial fitting or prediction based on deep learning neural network.

In one embodiment, the monotonous directional trajectory information of the moving object in the plurality of frames of first images may be obtained, and based on the monotonous directional trajectory information of the moving object, the first depth prediction information of the moving object in the plurality of frames of first images may be corrected, which may effectively solve the problem that the depth information of the moving object predicted by the monocular absolute depth prediction method is not accurate enough, and accordingly may improve the 3D visual effect of the three-dimensional images obtained in the conversion process from the two-dimensional images to the three-dimensional images, such that the into-screen/out-of-screen effect in the 3D display may be more natural and realistic.

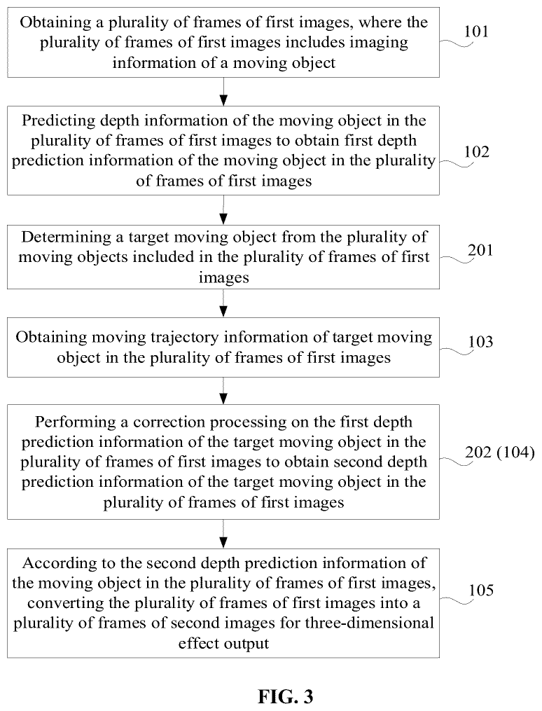

In an optional embodiment, the number of moving objects in the plurality of frames of first images may be multiple. Referring to the flowchart of the image processing method shown in FIG. 3, the image processing method provided by the present disclosure may further include following processes between 101 and 104:

At 201, the target moving object may be determined from the plurality of moving objects included in the plurality of frames of first images.

The execution order of 201, 102 and 103 may be not limited in the present disclosure; and above-mentioned three exemplary steps may be executed in parallel or in series in any order.

Optionally, the target moving object may be determined from the plurality of moving objects included in the plurality of frames of first images by a manual assignment manner. In one embodiment, exemplarily, the moving object assignment information inputted by the user may be obtained, and the moving object indicated by the moving object assignment information may be determined from the plurality of moving objects included in the first image as the target moving object.

The input manner of the moving object assignment information of the user may include, but may be not limited to, text input, voice input, and the manner of selecting the moving object to be assigned on the first image, and the like.

For the text input or voice input manner, when the execution subject detects that the first image contains the plurality of moving objects, the plurality of moving objects may be given different identifications and displayed on the first image; and then the user may input the moving object identification needed through the text or voice input manner, such that the assignment of the target moving object may be achieved. For example, it is assumed that the execution subject identifies three moving soccer balls as a soccer ball 1, a soccer ball 2 and a soccer ball 3 (or other identification manners, such as a moving object a, a moving object b and a moving object c) on the first image, in response to that the user inputs the identification of the soccer ball 2 through the text or voice input manner, the soccer ball 2 may be assigned as the target moving object.

For the manner of selecting the moving object to be assigned on the first image, exemplarily, the user may select (such as single-click, double-click and the like) the moving object needed on the content of the first image visually displayed, and the moving object selected by the user may be determined as the target moving object accordingly.

However, the manner of selecting the moving object to be assigned may be not limited in the present disclosure. In other implementation manners, the target moving object may also be automatically determined from the plurality of moving objects included in the plurality of fames of first images based on selection strategies. The selection strategies for the target moving object may include, but may be not limited to, at least one of the following: a) at the preset central region of the first image; b) the distance from the preset central region of the first image does not exceed a preset distance value; c) the object size is the top_k1 (top k1) of the object sizes of all moving objects; and d) the object clarity is the top_k2 (top k2) of the object clarity of all moving objects, where k1 and k2 may be integers greater than or equal to 1. Among the plurality of moving objects included in the first image, the moving object that meets above-mentioned selection strategies may be selected as the target moving object.

Furthermore, referring to FIG. 3, in one embodiment, 104 may be implemented as follows: at 202, the first depth prediction information of the target moving object in the plurality of frames of first images may be corrected to obtain the second depth prediction information of the target moving object in the plurality of frames of first images.

In one embodiment, when performing the correction processing of the first depth prediction information of the moving object, the correction processing may be performed only on the first depth prediction information of the target moving object in a targeted manner, which may reduce the workload of the scene conversion from two-dimensional images to three-dimensional images and save resource occupation, and may also ensure the accuracy of the depth prediction result of the moving object that the user focuses on (that is, the target moving object), thereby correspondingly ensuring that the moving object that the user focuses on in the conversion result has a realistic and natural into-screen/out-of-screen effect.

Subsequently, the plurality of frames of first images may be converted into the plurality of frames of second images for three-dimensional effect output according to the second depth prediction information of the target moving object and the first depth prediction information of other moving objects other than the target moving object.

It should be understood that in the scenario where the plurality of fames of first images contains the plurality of moving objects, the process of determining the target moving object from the plurality of moving objects may not be performed. In such implementation manner, the depth correction may be directly performed on each moving object. Compared with the implementation manner of only performing the depth correction on the target moving object, in such implementation manner, each moving object in the conversion result of the two-dimensional images to the three-dimensional images may have a realistic and natural into-screen/out-of-screen effect, but the processing workload and resource occupancy may be higher than the implementation manner of only performing the depth correction on the target moving object. In actual applications, adapted implementation manners may be selected according to actual needs.

In an optional embodiment, the plurality of frames of first images may also include imaging information of non-moving objects. The non-moving objects may include, but may be not limited to, imaging objects, such as background objects or foreground objects in a stationary state.

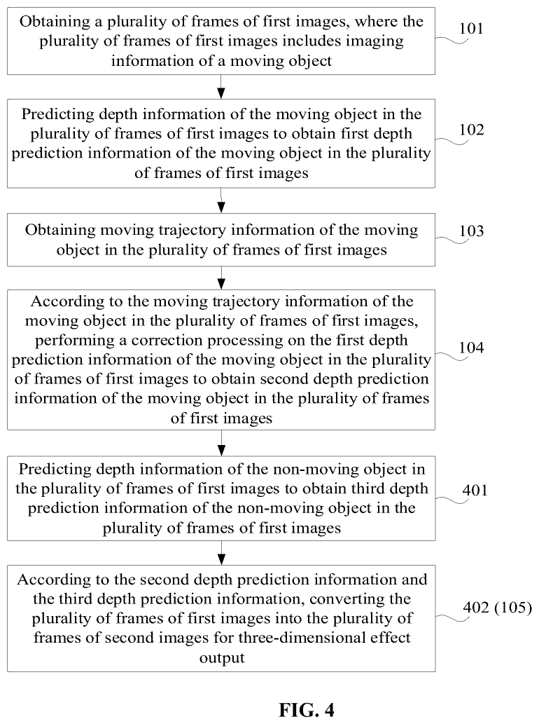

Referring to the flowchart of the image processing method shown in FIG. 4, the image processing method provided by the present disclosure may further include following processes before 105.

At 401, the depth information of the non-moving object in the plurality of frames of first images may be predicted to obtain the third depth prediction information of the non-moving object in the plurality of frames of first images.

It should be noted that the order of execution of 401, 102, 103 and 104 may be not limited in the present disclosure. 401 may be executed in parallel with any exemplary step in 102-104, or between any two exemplary steps executed in succession during the execution of 102-104, which may be determined according to actual situation of algorithm requirements and schedulable device resources.

The depth information prediction processing of the non-moving object in the plurality of frame of first images may be similar to the depth information prediction processing of the moving object, and the only difference may be that the depth prediction targets different objects, which may refer to the description of the depth information prediction processing of the moving object in above-mentioned embodiments for details. The depth information prediction processing of the non-moving object may be not described in detail herein.

In one embodiment, referring to FIG. 4, 105 in the method provided by the present disclosure (that is, converting the plurality of frames of first images into the plurality of frames of second images for three-dimensional effect output according to the second depth prediction information) may be exemplarily implemented as follows: at 402, according to the second depth prediction information and the third depth prediction information, the plurality of frames of first images may be converted into the plurality of frames of second images for three-dimensional effect output.

At 402, each of the plurality of frames of first images may be used in the conversion process, or only a part of the plurality of frames of first images may be used in the conversion process. For example, the frames of first images that are not used in the depth prediction may be eliminated and no longer processed at 402. However, it should be noted that for latter implementation manner, it needs to ensure that all frames of the first images that finally are used in the 2D to 3D processing (that is, the conversion processing of exemplary step 402) are guaranteed to have continuity in image contents, and the 3D contents finally converted have visual effect continuity correspondingly.

At 402, exemplarily, when converting the first image into the second image for three-dimensional effect output, the three-dimensional position information of the moving object and the three-dimensional position information of the non-moving object in the first image may be obtained, and the left disparity image and the right disparity image for three-dimensional effect output corresponding to the first image may be generated according to the three-dimensional position information of the moving object and the three-dimensional position information of the non-moving object. The left disparity image and the right disparity image may together form the second image for three-dimensional effect output corresponding to the first image. That is, the second image for three-dimensional effect output corresponding to the first image may include the left disparity image and the right disparity image corresponding to the first image.

The three-dimensional position information of the moving object in the first image may include the planar position corresponding to the moving object in the first image, and the second depth prediction information of the moving object in the first image. It should be understood that when the first image includes the plurality of moving objects and depth correction is only performed on selected target moving object, the three-dimensional position information of the target moving object in the first image may include the planar position corresponding to the target moving object in the first image, and the second depth prediction information of the target moving object in the first image; and the three-dimensional position information of the moving object other than the target moving object in the first image may include the planar position corresponding to the other moving object in the first image, and the first depth prediction information of the other moving object in the first image.

The three-dimensional position information of the non-moving object in the first image may include the planar position corresponding to the non-moving object in the first image, and the third depth prediction information corresponding to the non-moving object on the first image.

Subsequently, the left disparity image and the right disparity image corresponding to each frame of the first image may be interlaced, and interlaced result image may be displayed on the glass-free 3D display screen to present 3D visual effects such as into-screen/out-of-screen.

In one embodiment, the depth of the non-moving object in the plurality of frames of first images may be further predicted, and the 2D to 3D conversion process may be performed on the first image by combining the depth prediction result of the non-moving object and corrected depth prediction result of the moving object, which may further enhance the 3D visual effect of the images finally converted, thereby further enhancing the 3D experience of the users.

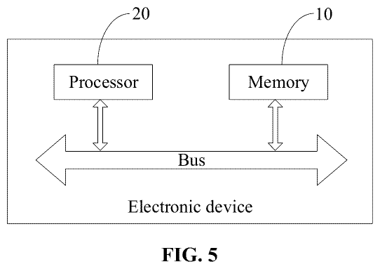

The present disclosure further provides an electronic device, the composition structure of the electronic device as shown in FIG. 5 may at least include a memory 10 configured to store a computer instruction set, where the computer instruction set may be implemented in the form of a computer program; and a processor 20 configured to implement the image processing method provided by any of above-mentioned method embodiments by executing the computer instruction set.

The processor 20 may be a central processing unit (CPU), an application-specific integrated circuit (ASIC), a digital signal processor (DSP), an application-specific integrated circuit (ASIC), a field programmable gate array (FPGA) or other programmable logic devices.

Optionally, the electronic device may also include a display device and/or a display interface which may be connected to an external display device.

Optionally, the electronic device may also include a camera assembly, and/or may be connected to an external camera assembly.

Furthermore, the electronic device may also include components such as a communication interface, a communication bus and the like. The memory, the processor and the communication interface may communicate with each other through the communication bus.

The communication interface may be configured for communication between electronic devices and other devices. The communication bus may be a peripheral component interconnect (PCI) bus or an extended industry standard architecture (EISA) bus and/or the like. The communication bus may be divided into an address bus, a data bus, a control bus and the like.

Various embodiments of the present disclosure further provide a non-transitory computer-readable storage medium, containing a computer program for when executed by one or more processors, performing an image processing method. The method includes obtaining a plurality of frames of first images, where the plurality of frames of first images includes imaging information of a moving object; predicting depth information of the moving object in the plurality of frames of first images to obtain first depth prediction information of the moving object in the plurality of frames of first images; obtaining moving trajectory information of the moving object in the plurality of frames of first images; according to the moving trajectory information of the moving object in the plurality of frames of first images, performing a correction processing on the first depth prediction information of the moving object in the plurality of frames of first images to obtain second depth prediction information of the moving object in the plurality of frames of first images; and according to the second depth prediction information of the moving object in the plurality of frames of first images, converting the plurality of frames of first images into a plurality of frames of second images for three-dimensional effect output.

Compared with the existing technology, the technical solutions provided by the present disclosure may achieve at least the following beneficial effects.

As disclosed above, the image processing method, the electronic device and the storage medium are provided in the present disclosure. The image processing method includes obtaining the plurality of frames of first images, where the plurality of frames of first images includes imaging information of the moving object; predicting depth information of the moving object in the plurality of frames of first images to obtain first depth prediction information of the moving object in the plurality of frames of first images; obtaining moving trajectory information of the moving object in the plurality of frames of first images; according to the moving trajectory information of the moving object in the plurality of frames of first images, performing the correction processing on the first depth prediction information of the moving object in the plurality of frames of first images to obtain second depth prediction information of the moving object in the plurality of frames of first images; and according to the second depth prediction information of the moving object in the plurality of frames of first images, converting the plurality of frames of first images into the plurality of frames of second images for three-dimensional effect output. For the conversion from two-dimensional images to three-dimensional images in the present disclosure, correction processing may be performed on the depth prediction information of the moving object based on the moving trajectory information of the moving object. Therefore, the depth prediction result of the corrected moving object may be closer to real depth of the moving object, and the into-screen/out-of-screen effect in the 3D display may be more realistic and natural, thereby improving 3D into-screen/out-of-screen effect experience of the users.

It should be noted that each embodiment in the present disclosure may be described in a progressive manner, and each embodiment may focus on differences from other embodiments. Same or similar parts between embodiments may be referred to each other.

For the convenience of description, above system, apparatus or device may be described in various modules or units according to functions. Obviously, when implementing the present disclosure, the function of each unit may be implemented in same or multiple software and/or hardware.

It may be seen from above description of implementation manners that those skilled in the art may clearly understand that the present disclosure may be implemented by means of software plus necessary general hardware platform. Based on such an understanding, the essence or a part making creative contribution of the technical solution of the present disclosure may be embodied in the form of a software product. The software product may be stored in a storage medium, such as ROM/RAM, a disk, an optical disk and/or the like; and may include a plurality of instructions to enable a computer device (which may be a personal computer, a server, a network device or the like) to execute the methods described in various embodiments or certain parts of embodiments of the present disclosure.

It should also be noted that in the present disclosure, relational terms such as first, second, third, fourth and the like may be merely configured to distinguish one entity or operation from another entity or operation and may not necessarily require or imply any such actual relationship or order between these entities or operations. Moreover, the terms “include”, “contain” or any other variations thereof may be intended to cover non-exclusive inclusion, such that a process, method, article, or equipment that includes a series of elements may not only include those elements, but also other elements that are not explicitly listed; or also include elements inherent to the process, method, article, or equipment. If there are no more restrictions, the elements defined by the sentence “include a . . . ” may not exclude the existence of other same elements in the process, method, article, or equipment including the elements.

The above may be merely optional implementation manners of the present disclosure. It should be noted that those skilled in the art may make certain improvements and modifications without departing from the principles of the present disclosure. Above-mentioned improvements and modifications should also be regarded as the scope of protection of the present disclosure.

What is claimed is:

1. An image processing method, comprising:
obtaining a plurality of frames of first images, wherein the plurality of frames of first images includes imaging information of a moving object;
predicting depth information of the moving object in the plurality of frames of first images to obtain first depth prediction information of the moving object in the plurality of frames of first images;
obtaining moving trajectory information of the moving object in the plurality of frames of first images;
according to the moving trajectory information of the moving object in the plurality of frames of first images, performing a correction processing on the first depth prediction information of the moving object in the plurality of frames of first images to obtain second depth prediction information of the moving object in the plurality of frames of first images; and
according to the second depth prediction information of the moving object in the plurality of frames of first images, converting the plurality of frames of first images into a plurality of frames of second images for three-dimensional effect output.

2. The method according to claim 1, wherein predicting the depth information of the moving object in the plurality of frames of first images includes:
predicting an absolute depth of the moving object in the plurality of frames of first images, wherein the absolute depth of the moving object includes a distance between each pixel on the moving object and an image obtaining apparatus, and the image obtaining apparatus is configured to implement imaging of the moving object.

3. The method according to claim 1, wherein predicting the depth information of the moving object in the plurality of frames of first images includes:
predicting depth information of pixels in the plurality of frames of first images to obtain pixel depth prediction information;
obtaining a moving object identification result which is obtained by identifying the moving object in the plurality of frames of first images; and
according to the pixel depth prediction information and the moving object identification result, determining the depth information of the moving object in the plurality of frames of first images.

4. The method according to claim 1, wherein obtaining the moving trajectory information of the moving object in the plurality of frames of first images includes:
obtaining monotonic directional trajectory information of the moving object in the plurality of frames of first images, wherein the monotonic directional trajectory information is configured to characterize a monotonic change direction of depth information monotonic increase or monotonic decrease of the moving object in a corresponding time period or a corresponding frame number range.

5. The method according to claim 4, wherein obtaining the monotonic directional trajectory information of the moving object in the plurality of frames of first images includes one of following:
obtaining the monotonous directional trajectory information of the moving object which is configured and inputted according to a moving process of the moving object in the plurality of frames of first images; or
obtaining the monotonous directional trajectory information of the moving object which is analyzed and determined according to a moving process of the moving object in the plurality of frames of first images.

6. The method according to claim 1, wherein according to the moving trajectory information of the moving object in the plurality of frames of first images, performing the correction processing on the first depth prediction information of the moving object in the plurality of frames of first images includes:
according to the moving trajectory information, determining a change feature of the moving trajectory of the moving object; and
according to the change feature of the moving trajectory of the moving object, performing the correction processing on the first depth prediction information of the moving object in the plurality of frames of first images.

7. The method according to claim 1, wherein a plurality of moving objects is included in the plurality of frames of first images; and before performing the correction processing on the first depth prediction information of the moving object in the plurality of frames of first images according to the moving trajectory information of the moving object in the plurality of frames of first images, the method further includes:
determining a target moving object from the plurality of moving objects included in the plurality of frames of first images.

8. The method according to claim 7, wherein performing the correction processing on the first depth prediction information of the moving object in the plurality of frames of first images includes:
performing the correction processing on the first depth prediction information of the target moving object in the plurality of frames of first images.

9. The method according to claim 1, wherein the plurality of frames of first images further includes imaging information of a non-moving object; and the method further includes:
predicting depth information of the non-moving object in the plurality of frames of first images to obtain third depth prediction information of the non-moving object in the plurality of frames of first images, wherein:
converting the plurality of frames of first images into the plurality of frames of second images for three-dimensional effect output according to the second depth prediction information includes converting the plurality of frames of first images into the plurality of frames of second images for three-dimensional effect output according to the second depth prediction information and the third depth prediction information.

10. An electronic device, comprising:
a memory, configured to store a computer program; and
one or more processors, configured to, when the computer program is executed, perform:
obtaining a plurality of frames of first images, wherein the plurality of frames of first images includes imaging information of a moving object;
predicting depth information of the moving object in the plurality of frames of first images to obtain first depth prediction information of the moving object in the plurality of frames of first images;
obtaining moving trajectory information of the moving object in the plurality of frames of first images;
according to the moving trajectory information of the moving object in the plurality of frames of first images, performing a correction processing on the first depth prediction information of the moving object in the plurality of frames of first images to obtain second depth prediction information of the moving object in the plurality of frames of first images; and
according to the second depth prediction information of the moving object in the plurality of frames of first images, converting the plurality of frames of first images into a plurality of frames of second images for three-dimensional effect output.

11. The electronic device according to claim 10, wherein the one or more processors are further configured to:
predict an absolute depth of the moving object in the plurality of frames of first images, wherein the absolute depth of the moving object includes a distance between each pixel on the moving object and an image obtaining apparatus, and the image obtaining apparatus is configured to implement imaging of the moving object.

12. The electronic device according to claim 10, wherein the one or more processors are further configured to:
predict depth information of pixels in the plurality of frames of first images to obtain pixel depth prediction information;
obtain a moving object identification result which is obtained by identifying the moving object in the plurality of frames of first images; and
according to the pixel depth prediction information and the moving object identification result, determine the depth information of the moving object in the plurality of frames of first images.

13. The electronic device according to claim 10, wherein the one or more processors are further configured to:
obtain monotonic directional trajectory information of the moving object in the plurality of frames of first images, wherein the monotonic directional trajectory information is configured to characterize a monotonic change direction of depth information monotonic increase or monotonic decrease of the moving object in a corresponding time period or a corresponding frame number range.

14. The electronic device according to claim 13, wherein the one or more processors are further configured to perform one of following:
obtaining the monotonous directional trajectory information of the moving object which is configured and inputted according to a moving process of the moving object in the plurality of frames of first images; or
obtaining the monotonous directional trajectory information of the moving object which is analyzed and determined according to a moving process of the moving object in the plurality of frames of first images.

15. The electronic device according to claim 10, wherein the one or more processors are further configured to:
according to the moving trajectory information, determine a change feature of the moving trajectory of the moving object; and
according to the change feature of the moving trajectory of the moving object, perform the correction processing on the first depth prediction information of the moving object in the plurality of frames of first images.

16. The electronic device according to claim 10, wherein a plurality of moving objects is included in the plurality of frames of first images; and before performing the correction processing on the first depth prediction information of the moving object in the plurality of frames of first images according to the moving trajectory information of the moving object in the plurality of frames of first images, the one or more processors are further configured to:
determine a target moving object from the plurality of moving objects included in the plurality of frames of first images.

17. The electronic device according to claim 16, wherein the one or more processors are further configured to:
perform the correction processing on the first depth prediction information of the target moving object in the plurality of frames of first images.

18. The electronic device according to claim 10, wherein the plurality of frames of first images further includes imaging information of a non-moving object; and the one or more processors are further configured to:
predict depth information of the non-moving object in the plurality of frames of first images to obtain third depth prediction information of the non-moving object in the plurality of frames of first images, wherein:
converting the plurality of frames of first images into the plurality of frames of second images for three-dimensional effect output according to the second depth prediction information includes converting the plurality of frames of first images into the plurality of frames of second images for three-dimensional effect output according to the second depth prediction information and the third depth prediction information.

19. A non-transitory computer-readable storage medium containing a computer program that when being executed, causes one or more processors to perform:
obtaining a plurality of frames of first images, wherein the plurality of frames of first images includes imaging information of a moving object;
predicting depth information of the moving object in the plurality of frames of first images to obtain first depth prediction information of the moving object in the plurality of frames of first images;
obtaining moving trajectory information of the moving object in the plurality of frames of first images;
according to the moving trajectory information of the moving object in the plurality of frames of first images, performing a correction processing on the first depth prediction information of the moving object in the plurality of frames of first images to obtain second depth prediction information of the moving object in the plurality of frames of first images; and
according to the second depth prediction information of the moving object in the plurality of frames of first images, converting the plurality of frames of first images into a plurality of frames of second images for three-dimensional effect output.

20. The storage medium according to claim 19, wherein the one or more processors are further configured to:
predict an absolute depth of the moving object in the plurality of frames of first images, wherein the absolute depth of the moving object includes a distance between each pixel on the moving object and an image obtaining apparatus, and the image obtaining apparatus is configured to implement imaging of the moving object.
